(19) United States
(12) Patent Application Publication
(10) Pub. No.: US 2005/0041095 A1
(43) Pub. Date: Feb. 24, 2005

(54) Stereoscopic image acquisition device

(76) Inventors: Bernie Butler-Smith, Malibu Lake, CA (US); Steve J. Schklair, Altadena, CA (US)

Correspondence Address: BAKER & HOSTETLER LLP, Washington Square, Suite 1100, 1050 Connecticut Avenue, N.W., WASHINGTON, DC, 20036, US

(21) Appl. No.: 10/840,659

(22) Filed: May 7, 2004

Related U.S. Application Data
(60) Provisional application No. 60/468,260, filed on May 7, 2003.

(51) Int. Cl. H04N 13/00

(52) U.S. Cl. 348/42

(57) ABSTRACT

This invention provides a method of combining two standard video streams, into one standard video stream, in such a way that it can be encoded efficiently, and that it can enhance the TV viewing experience by presenting Stereoscopic 3D imagery, dual-view display capability, panoramic viewing, and user interactive “pan-and-scan”. The video standards for High Definition Video are used, which are governed by the ATSC and SMPTE standards bodies. Having a dual stream of standard video, which occupies now a single stream of standard video, provides a means to use the standard installed base of equipment for recording, transmission, playback and display.

### CROSS-REFERENCE TO RELATED APPLICATIONS

This application claims priority to and is a non-provisional of U.S. provisional patent application entitled, Stereoscopic 3D TV System: End-to-End Solution, filed May 7, 2003, having a Ser. No. 60/468,260, the disclosure of which is hereby incorporated by reference in its entirety.

### FIELD OF THE INVENTION

The present invention relates generally to a method used to combine dual streams of video into a standard single stream of video. More particularly, the present invention relates to a method of combining a dual stream of standard video, to occupy a single stream of standard video, providing a means to enhance a viewers experience in several ways.

### BACKGROUND OF THE INVENTION

Stereoscopic-3D image acquisition is usually done using two video cameras, mounted side-by-side, or in a beam-splitter configuration. Each camera has its own lens, and image sensor chip/s to acquire the stereo image pair.

This invention provides a means of combining the image sensor chip from both cameras into a single image sensor chip, and combining the light path from both lenses or a single lens with dual optical in-points onto the same chip. This simplifies the capture of 3D images, guaranteeing synchronization between the two images, and eliminates all issues usually associated with dual camera capture.

### SUMMARY OF THE INVENTION

This invention provides a means of combining the image sensor chip from what would normally required from two cameras, into a single image sensor chip, and combining the light path from both lenses onto the same chip. This simplifies the optical path of the system.

The Camera is based on a single high-resolution CMOS or CCD Sensor, such that both left-eye and right-eye images are acquired by the same sensor. The purpose is to equalize and simplify the optical path between lenses and sensor, and to avoid using a shutter. The left-eye and right-eye images are either sides-by-side, or above-and-below.

Sensors are available to acquire images by “binning” adjacent pixels, either horizontally, vertically, or in both directions. For example a 3840×2160 (Quad-HDTV) sensor can be “binned” vertically or horizontally to create two adjacent image areas required.

This invention provides a means of creating a stereoscopic video camera by using a single image acquisition device, or image sensor, to capture the light path from two lenses, onto the single substrate surface of the image sensor device. The image sensor device is double the size of what would be used to capture a single image source, and is doubled either horizontally or vertically, to accommodate both image sources. This simplifies the capture of 3D images, guaranteeing synchronization between the two images, and eliminates all issues usually associated with dual camera capture.

### BRIEF DESCRIPTION OF THE DRAWINGS

For a better understanding of the present invention, reference is made to the following descriptions taken in conjunction with the accompanying drawings, in which, by example:

FIG. 1 shows an example of a 3840×1080 pixel image sensor, which consists of two horizontally adjacent 1920×1080 pixel image sensors, side by side.

FIG. 2 shows an example of a 1920×2160 pixel image sensor, which consists of two vertically adjacent 1920×1080 pixel image sensors, one above the other.

### DETAILED DESCRIPTION

This invention provides a means of combining the image sensor chip from what would normally required from two cameras, into a single image sensor chip, and combining the light path from both lenses onto the same chip. This simplifies the optical path of the system.

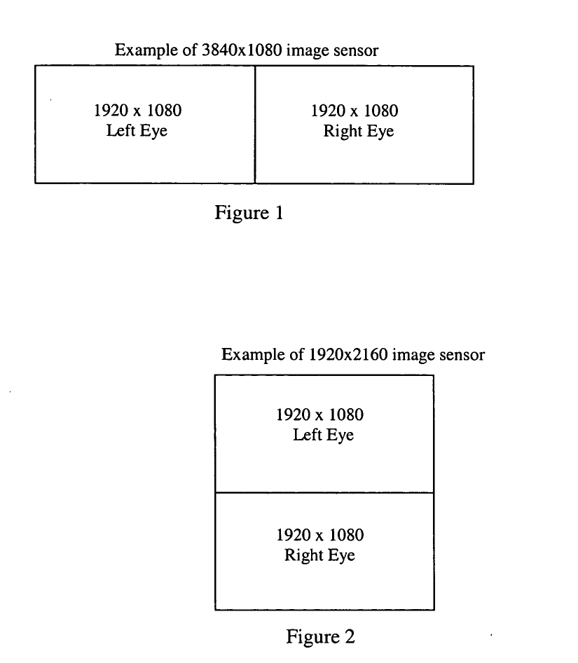

The Camera is based on a single high-resolution CMOS or CCD Sensor, such that both left-eye and right-eye images are acquired by the same sensor [FIGS. 1, 2]. The purpose is to equalize and simplify the optical path between lenses and sensor, and to avoid using a shutter. The left-eye and right-eye images are either sides-by-side [FIG. 1], or above-and-below [FIG. 2].

Sensors are available to acquire images by “binning” adjacent pixels, either horizontally, vertically, or in both directions. For example a 3840×2160 (Quad-HDTV) sensor can be “binned” vertically or horizontally to create two adjacent image areas required.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1) A method of capturing stereoscopic 3D television by means of a single chip substrate image sensor, to capture two light paths of the “left-eye” and “right-eye” stereo image pair.

2) The method of claim 1, in which the sensor is CCD (Charge Coupled Device).

3) The method of claim 1, in which the sensor is CMOS (Complimentary Metal Oxide Semiconductor).

4) A method of claim 1, in which the image sensor captures the image pair in two horizontally adjacent rectangular areas on the surface of the image sensor.

5) A method of claim 1, in which the image sensor captures the image pair in two vertically adjacent rectangular areas on the surface of the image sensor.
